(19) United States
(12) Patent Application Publication
(10) Pub. No.: US 2009/0034244 A1
(43) Pub. Date: Feb. 5, 2009

(54) LIGHTING APPARATUS

(76) Inventor: Stefano Tabarelli De Fatis, Schio (IT)

Correspondence Address: NIXON & VANDERHYE, PC, 901 NORTH GLEBE ROAD, 11TH FLOOR, ARLINGTON, VA, 22203, US

(21) Appl. No.: 11/989,529

(22) PCT Filed: Jul. 4, 2006
(86) PCT No.: PCT/EP2006/063837

§ 371 Date: Apr. 30, 2008

(30) Foreign Application Priority Data
Jul. 27, 2005 (IT) MO2005A000193

(51) Int. Cl. F21V 33/00

(52) U.S. Cl. 362/154

(57) ABSTRACT

An apparatus comprises a container, suitable for containing a plant and a respective culture substrate, and a lighting arrangement associated with said container.

The invention relates to a lighting apparatus that is usable in internal and external environments.

During nocturnal hours, a user located inside a building may need to enter and/or move in a room without being able to use the artificial lighting devices present therein such as, for example, ceiling lamps and/or wall lamps.

This may occur, for example, due to a sudden fault in the aforementioned devices or due to a sudden interruption to the electric power supply.

Further, a user who enters a room that is not lit and seeks the switch, normally a wall switch, operating the lighting devices present therein is forced to move in the dark for a more or less short period of time that is required to identify the switch.

A user could lastly find it convenient to enter and move during the nocturnal hours in a room, in which children or sick people are sleeping, without switching on the lights with which the room is provided and thereby avoiding disturbing the rest of the persons accommodated therein.

Nevertheless, the need and/or the convenience of moving in the dark in a room entail for a user a substantial risk of accident and/or of financial harm. For example, a user may accidentally knock against objects, which may also be voluminous, that are present in the room and injure himself. Or the user may accidentally knock and break precious but substantially fragile ornamental objects.

Lighting devices for internal environments are known, so-called night lights, producing a light that is of reduced intensity but is sufficient to enable a user to move in a room in conditions of safety, without disturbing persons who, for example, are sleeping in that room.

A drawback of these devices consists of the fact that as they are usually fixed to architectural elements they cannot be moved easily from one room to another of a building or from one zone to another of the same room, depending on user needs.

Further, these devices are supplied by an electrical grid system and are thus affected by any faults that may occur in the latter.

In external environments, such as, for example, the courtyards of buildings, inappropriate artificial lighting may cause significant drawbacks.

For example, for a driver of a motor vehicle entering during the evening or nocturnal hours a courtyard that is insufficiently lighted it may be uncomfortable to perform parking manoeuvres, for example reversing. The inappropriate ambient lighting in fact causes the driver not to be always able to assess in an optimum manner the space that is actually available for performing the aforementioned manoeuvres, and this implies a significant risk of accidents. For example, the vehicle may crash into benches located inside the courtyard, causing damage and being damaged in turn. If the aforementioned manoeuvres are then performed fast, there is also a significant risk of injuries that the driver may sustain following the crash.

In order to avoid all this it would be necessary to increase the artificial lighting in the courtyard, but this solution can be made substantially difficult due to the presence of an obsolete electric system and/or be undesired because of the costs to be sustained.

An object of the invention is to improve known lighting apparatuses that are usable in internal and/or external environments.

Another object is to provide a lighting apparatus, to be used in internal and/or external environments, which is substantially simple and inexpensive to produce.

A further object is to provide a lighting apparatus, to be used in internal and/or external environments, which is usable with reduced energy consumption.

Another further object is to provide a lighting apparatus, to be used in internal and/or external environments, which is easily movable from an environment to the other and/or from a zone to the other of the same environment.

According to the invention, an apparatus is provided comprising a container, suitable for containing a plant and a respective culture substrate, and a lighting arrangement associated with said container.

Owing to the invention, a lighting apparatus is made available that is substantially simple and inexpensive to manufacture. In fact, common plant pots are usable as containers, to the walls of which the lighting arrangement is fixed.

Thus the apparatus, having the dimensions and the shape of a common plant pot, is substantially easy to move and can be moved by a user from a room to another of the same building and/or from a zone to another of the same room, according to needs.

In an embodiment, the lighting arrangement comprises a LED supplied by an electric battery that is in turn rechargeable through a photovoltaic cell. This enables the energy that is associated with solar radiation to be accumulated during daylight hours and enables this energy to be used during nocturnal hours to keep the LED switched on. In this way, the lighting arrangement does not need to be supplied by an electrical grid system, which enables a significant saving of energy and consequently money to be made. Further, a possible malfunction of the aforementioned electric system cannot adversely affect the efficiency of the lighting apparatus provided by the invention.

If the apparatus is located in a room of a building, a user who enters that room during the nocturnal hours and in the absence of other lighting devices of known type can move in the dark in a substantially easy manner owing to the light emitted by the apparatus, thus avoiding knocking into voluminous and/or precious objects present in the room.

Further, the user can move in the room in conditions of safety without using the known lighting devices present therein, if this could disturb, for example, children and/or sick persons who are sleeping in the room.

In another embodiment, the apparatus provided by the invention is made in the form of a pot for street furniture, for example a plant tub, and can be used in external environments, for example courtyards, provided with poor artificial lighting.

By placing a certain number of apparatuses in zones of a courtyard that have been suitably chosen, it is possible to indicate the space that is actually usable by a motor vehicle to perform manoeuvres inside the courtyard and thus minimise the risk of accidents in the evening or nocturnal hours.

In a further embodiment, the lighting arrangement comprises LEDs that are coloured and/or arranged on the container so as to form a pattern, thus making the apparatus a decorating element for both internal and external environments. In particular, this embodiment constitutes a valid alternative to the traditional night lights for children.

The invention will be better understood and implemented with reference to the attached drawings that show some exemplifying but non-limitative embodiments thereof, in which:

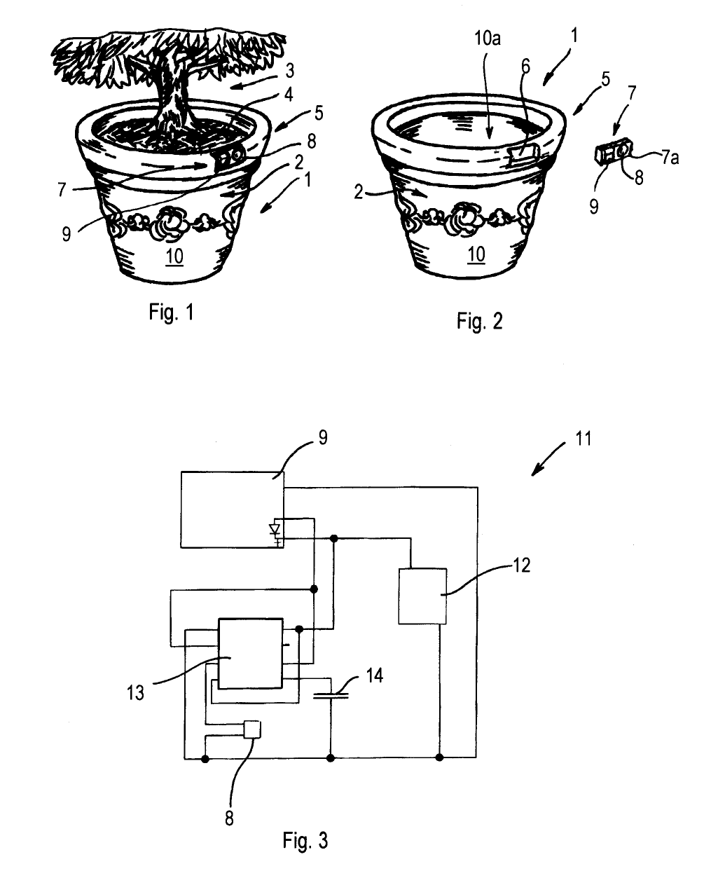

FIG. 1 is a perspective, fragmentary and incomplete view showing an apparatus comprising a lighting arrangement associated with a plant container;

FIG. 2 is a perspective and exploded view of the lighting arrangement and of the container in FIG. 1;

FIG. 3 is a diagram showing a configuration of an electric circuit comprised in the lighting arrangement in FIG. 1.

With reference to FIGS. 1 to 3, a lighting apparatus 1 comprises a pot 2, comprising a side wall 10 delimiting an internal cavity 10a, a bottom wall (not shown) and a free edge 5 opposite the bottom wall. In use, in the internal cavity 10a a suitable culture substrate 4 is contained, for example soil, in which a plant 3 is placed. The pot 2 may be made of terracotta, plastics or of any other suitable material. In a portion of the free edge 5 opposite the internal cavity 10a a recess 6 is obtained, which is made shapingly coupled with a lighting device 7. The recess 6 is obtained through a projecting element, having preset shape and dimensions, with which a mould (not shown) is provided that is used to produce the pot 2.

The lighting device 7 is substantially shaped as a rectangular plate and is fixed to the inside of the recess 6, for example by gluing. The lighting device 7 is provided with a power-supply circuit 11 (disclosed in greater detail below) comprising, amongst other things, a lighting element 8 of known type, for example a light emitting diode (LED), a rechargeable electric battery 12 and a photovoltaic cell 9, of known type. The rechargeable electric battery 12 supplies, in use, the LED 8 and is recharged by the photovoltaic cell 9. The LED 8 and the photovoltaic cell 9 are arranged on a face 7a of the lighting device 7 that in use is opposite the recess 6.

In an embodiment that is not shown, the recess 6 is obtained in a portion of the free edge 5 facing the internal cavity 10a, so that the lighting device 7 emits light in the direction of the plant 3.

In another embodiment that is not shown, the recess 6 is obtained in a portion of the free edge 5 opposite the internal cavity 10a and adjacent to the side wall 10a, in such a way that the lighting device 7 emits light in the direction of a surface, for example a floor, on which the pot 2 rests in use.

In a further embodiment that is not shown, the recess 6 is obtained in a portion of the side wall 10.

In a still further embodiment that is not shown, the pot 2 is devoid of the recess 6 and the lighting device 7 is fixed directly on the free edge 5 and/or on the wall 10 of the pot 2.

In a further other embodiment that is not shown, the lighting device 7 comprises coloured LEDS.

In another further embodiment that is not shown, the lighting device 7 comprises a plurality of LEDs, arranged on the free edge 5 and/or on the side wall 10 of the pot 2 so as to form a decorative pattern.

In another still further embodiment that is not shown, the apparatus 1 comprises a plant tub, of known type, with which a plurality of lighting devices 7 is arranged along the upper edge and/or the side wall of the tub.

With particular reference to FIG. 3, the power-supply circuit 11 is controlled, in use, through a controlling arrangement of known type, for example an integrated circuit 13. In the power-supply circuit 11 the photovoltaic cell 9, the LED 8, the rechargeable electric battery 12, the integrated circuit 13 and a capacitor 14 are comprised, the capacitor 14 acting as a voltage stabiliser.

In use, during daylight hours, the energy associated with the solar luminous radiation incident on the photovoltaic cell 9 of known type is converted by the latter into electric energy and used to charge a rechargeable electric battery 12 of known type, for example a nickel-cadmium battery. The integrated circuit 13, for example a TLC 555 circuit of known type, detects the electric voltage produced by the photovoltaic cell 9 through the effect of the incident solar radiation. At dusk, when the intensity of the incident solar radiation decreases progressively, the voltage of the photovoltaic cell 9 decreases until it becomes less than a preset threshold value. The integrated circuit 13 intervenes enabling the rechargeable electric battery 12 to supply the LED 8, for example a white 3.6-volt LED of known type. The LED 8 switches on and remains switched on during the nocturnal hours, i.e. as long the voltage of the photovoltaic cell 9 remains below the threshold value. From the following dawn, the solar luminous radiation increases progressively and again strikes on the photovoltaic cell 9. As a result, the voltage of the photovoltaic cell 9 increases until it reaches and exceeds the threshold value. This is detected by the integrated circuit 13, which interrupts the connection between the rechargeable electric battery 12 and the LED 8. The latter switches off and the rechargeable electric battery 12 is recharged by the photovoltaic cell 9 during daylight hours until, at the next dusk, the voltage of the photovoltaic cell 9 again becomes less than the threshold value and the integrated circuit 13 again switches on the LED 8. The integrated circuit 13 thus acts as a timer, regulating switching on and switching off of the LED 8 during the 24 hours.

The natural alternation between light and darkness over 24 hours enables the lighting device 7, and thus the apparatus 1, to operate using only solar light, which is stored during the day and used during the nocturnal hours. This enables a substantial energy saving, and consequently, money saving to be made.

In an embodiment that is not shown, the controlling arrangement of the power-supply circuit 11 comprises a darkness sensor, of known type. During daylight hours the darkness sensor, by detecting an environmental luminosity that is above a preset threshold value, keeps the LED 8 switched off and enables the photovoltaic cell 9 to recharge the rechargeable electric battery 12. At dusk, the darkness sensor detects an environmental luminosity that is below the threshold value and enables the rechargeable electric battery 12 to supply the LED 8, which switches on and remains switched on during the nocturnal hours. As from the subsequent dawn, environmental luminosity increases progressively until it reaches and overcomes the threshold value that is detectable by the darkness sensor. The latter interrupts the supply to the LED 8, which switches off, and enables the photovoltaic cell 9 to recharge the rechargeable electric battery 12 again.

In another embodiment that is not shown, the controlling arrangement of the power-supply circuit 11 comprises a timing device (timer) of known type, that is different from the aforementioned integrated circuit 13.

In a further embodiment that is not shown, the rechargeable electric battery 12 is located outside the lighting device 7, in a further recess made in the bottom wall of the pot 2.

In another further embodiment that is not shown, the rechargeable electric battery 12 is located outside the lighting device 7 and is contained in a box fixed inside the free edge 5 of the pot 2.

In a further other embodiment that is not shown, the power-supply circuit 11 is powered by non-rechargeable electric batteries.

In a still further embodiment that is not shown, the power-supply circuit 11 is connected to the electrical grid system by means of an electric cable with which the lighting device 7 is provided.

In another still further embodiment that is not shown, the controlling arrangement of the power-supply circuit 11 comprises a switch of known type that is comprised in the lighting device 7 and can be actuated by a user.

In a still further other embodiment that is not shown, the controlling arrangement of the power-supply circuit 11 is made in such a way as to be able to switch on the LED 8 in an intermittent and/or continuous manner.

The apparatus 1 can be made in such a way as to have substantially reduced dimensions, such as to enable the use thereof in internal environments. In this way, the apparatus 1, resting on a floor or located on a shelf of a piece of furniture, acts as a light signal for anybody who enters a room in reduced environmental luminosity conditions.

The apparatus 1 can be used in external environments provided with poor artificial lighting and be made in the aforementioned form of plant tub. In this way, a driver of a motor vehicle can take advantage of light signals that are able to facilitate manoeuvres performed in conditions of reduced environmental luminosity and in substantially reduced spaces, for example courtyards of buildings.

Further, the apparatus 1 can be provided with a lighting device 7 comprising a plurality of LEDs, arranged in such a way as to form a decorative pattern. In this way, the apparatus 1 can also be used as an ornamental element, both in internal environments and in external environments.

1.-32. (canceled)

33. Apparatus comprising a container, suitable for containing a plant and a respective culture substrate, and a lighting arrangement associated with said container.

34. Apparatus according to claim 33, wherein said container comprises a side wall delimiting an internal cavity of said container, said side wall being interposed between a free edge of said container and a bottom wall of said container opposite said free edge.

35. Apparatus according to claim 34, wherein said lighting arrangement is associated with portions of said edge.

36. Apparatus according to claim 35, wherein said portions of said edge are opposite said internal cavity.

37. Apparatus according to claim 35, wherein said lighting arrangement is associated with other portions of said edge, said other portions facing said internal cavity.

38. Apparatus according to claim 35, wherein said lighting arrangement is associated with further portions of said edge, said further portions being opposite said internal cavity and adjacent to said side wall.

39. Apparatus according to claim 34, wherein said lighting arrangement is associated with portions of said side wall.

40. Apparatus according to claim 33, wherein said lighting arrangement is located in a recess obtained in said container.

41. Apparatus according to claim 33, wherein said lighting arrangement comprises a lighting element supplied through a power-supply circuit.

42. Apparatus according to claim 41, wherein said lighting element comprises a LED.

43. Apparatus according to claim 41, wherein said power-supply circuit comprises a rechargeable electric battery arranged for supplying, in use, said lighting element.

44. Apparatus according to claim 43, wherein said power-supply circuit comprises a photovoltaic cell arranged for charging, in use, said rechargeable electric battery.

45. Apparatus according to claim 41, wherein said power-supply circuit comprises a controlling arrangement for controlling switching on and/or switching off of said lighting element.

46. Apparatus according to claim 45, wherein said controlling arrangement comprises an integrated circuit.

47. Apparatus according to claim 46, wherein said power-supply circuit comprises a photovoltaic cell arranged for charging, in use, a rechargeable electric battery, said rechargeable electric battery being arranged for supplying said lighting element, wherein said integrated circuit is made in such a way as to be able to detect, in use, a value of an electric voltage, said electric voltage being produced by said photovoltaic cell through the effect of an incident luminous radiation, and to compare said value with a preset threshold value.

48. Apparatus according to claim 47, wherein said integrated circuit is arranged for enabling said photovoltaic cell, in use, to recharge said rechargeable electric battery when said value is greater than said threshold value.

49. Apparatus according to claim 47, wherein said integrated circuit is arranged for enabling said rechargeable electric battery, in use, to supply said lighting element when said value is less than said threshold value.

50. Apparatus according claim 46, wherein said integrated circuit is a timing circuit of type 555.

51. Apparatus according to claim 50, wherein said timing circuit is a TLC 555 circuit.

52. Apparatus according to claim 45, wherein said controlling arrangement comprises a darkness sensor that, in use, is arranged for detecting a value of environmental luminosity and causing the switching on of said lighting element when said value of environmental luminosity is less than a preset threshold value.

53. Apparatus according to claim 52, wherein said darkness sensor, in use, is arranged for detecting said value of environmental luminosity and causing the switching off of said lighting element when said value of environmental luminosity is greater than said preset threshold value.

54. Apparatus according to claim 41, wherein said power-supply circuit comprises a non-rechargeable electric battery.

55. Apparatus according to claim 41, wherein said power-supply circuit is connected to an electrical grid system.

56. Apparatus according to claim 45, wherein said controlling arrangement further comprises a switch arranged for being actuated by a user.

57. Apparatus according to claim 41, wherein said lighting element emits white light.

58. Apparatus according to claim 41, wherein said lighting element emits coloured light.

59. Apparatus according to claim 45, wherein said controlling arrangement is made in such a way as to be able to switch on said lighting element in an intermittent and/or continuous manner.

60. Apparatus according to claim 43, wherein said container comprises a side wall delimiting an internal cavity of said container, said side wall being interposed between a free edge of said container and a bottom wall of said container opposite said free edge, wherein said rechargeable electric battery is housed in a further recess obtained in said bottom wall of said container.

61. Apparatus according to claim 43, wherein said container comprises a side wall delimiting an internal cavity of said container, said side wall being interposed between a free edge of said container and a bottom wall of said container opposite said free edge, wherein said rechargeable electric battery is housed in a box associated with said free edge of said container.

62. Apparatus according to claim 33, comprising a plurality of said lighting arrangements, said lighting arrangements being arranged on said container so as to form a decorative pattern.

63. Apparatus according to claim 33, wherein said container is in the shape of a pot.

64. Apparatus according to claim 33, wherein said container is in the shape of a plant tub.
